(19) United States
(12) Patent Application Publication
(10) Pub. No.: US 2008/0172580 A1
(43) Pub. Date: Jul. 17, 2008

(54) Collecting and Reporting Code Coverage Data

(75) Inventors: Brian D. Davia, Seattle, WA (US); Micah Lewis, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/623,172

(22) Filed: Jan. 15, 2007

(51) Int. Cl. G06F 11/36

(52) U.S. Cl. 714/38

(57) ABSTRACT

Code coverage data may be collected and reported. First, in response to running a plurality of different test cases, a first plurality of traces may be received. Each of the first plurality of traces may respectively correspond to a first plurality of outputs respectively produced by running each of the plurality of different test cases on a software program. Next, in response to a plurality of users running the software program, a second plurality of traces may be received. Each of the second plurality of traces may respectively correspond to a second plurality of outputs produced by the users running the software program. Then, the first plurality of traces may be compared to the second plurality of traces. A report may be created showing the comparison.

### RELATED APPLICATIONS

Related U.S. patent application Ser. No. __/___,___, entitled “Saving Code Coverage Data for Analysis,” Ser. No. __/___,___, entitled “Applying Function Level Ownership to Test Metrics,” and Ser. No. __/___,___, entitled “Identifying Redundant Test Cases,” assigned to the assignee of the present application and filed on even date herewith, are hereby incorporated by reference.

### BACKGROUND

When developing software, programming modules may be tested during the development process. Such testing may produce code coverage data. Code coverage data may comprise metrics that may indicate what code pieces within a tested programming module have been executed during the programming module's test. The code coverage data may be useful in a number of ways, for example, for prioritizing testing efforts.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Code coverage data may be collected and reported. First, in response to running a plurality of different test cases, a first plurality of traces may be received. Each of the first plurality of traces may respectively correspond to a first plurality of outputs respectively produced by running each of the plurality of different test cases on a software program. Next, in response to a plurality of users running the software program, a second plurality of traces may be received. Each of the second plurality of traces may respectively correspond to a second plurality of outputs produced by the users running the software program. Then, the first plurality of traces may be compared to the second plurality of traces. A report may be created showing the comparison.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for collecting and reporting code coverage data; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A software testing tool may be used by a computer program tester to collect code coverage data. The code coverage data may allow the tester to see which code pieces (e.g. code lines) are executed while testing a software program. The testers may use the software testing tool to collect code coverage data during an automation run (e.g. executing a plurality of test cases) to see, for example, which code lines in the software program were executed by which test cases during the automation run.

A test case may be configured to test aspects of the software program. To do so, the test case may operate on a binary executable version of the software program populated with coverage code. For example, the test case may be configured to cause the binary executable version to open a file. Consequently, the coverage code in the binary executable version may be configured to produce the code coverage data configured to indicate what code within the binary executable version was used during the test. In this test example, the coverage code may produce the code coverage data indicating what code within the binary executable version was executed during the file opening test case.

A trace may comprise a code coverage unit data collected from a test case run. The trace may comprise code blocks executed from the beginning to the end of the test case. For example, the tester may collect one trace for each test case run. On occasion, it may be useful to dig deeper to see exactly which code blocks (or even code lines) are executed by a particular test case or a set of test cases.

Collecting code coverage data during software testing may be useful for identifying code portions that may require testing either: i) to achieve a greater confidence in testing efforts; or ii) because the code has not been tested. Due to the software program's size, it may not be reasonable to write enough test cases to generate 100% code coverage. Given that all code may not be covered in testing, it may be useful for testers to know what code is covered by formal testing as compared to what code is covered by users who use the software in, for example, everyday use. Without knowing where the differences are, a tester may rely on the tester's own judgment to decide what additional testing may be warranted.

Consistent with embodiments of the invention, code coverage data may be collected from end-users. The collected data may then be compare to a baseline data set collected during formal code testing. Results of this comparison may be made available to testers. Accordingly, testers may be provided information about were code covered during formal testing is the same as, or differs from, code covered by users in everyday use.

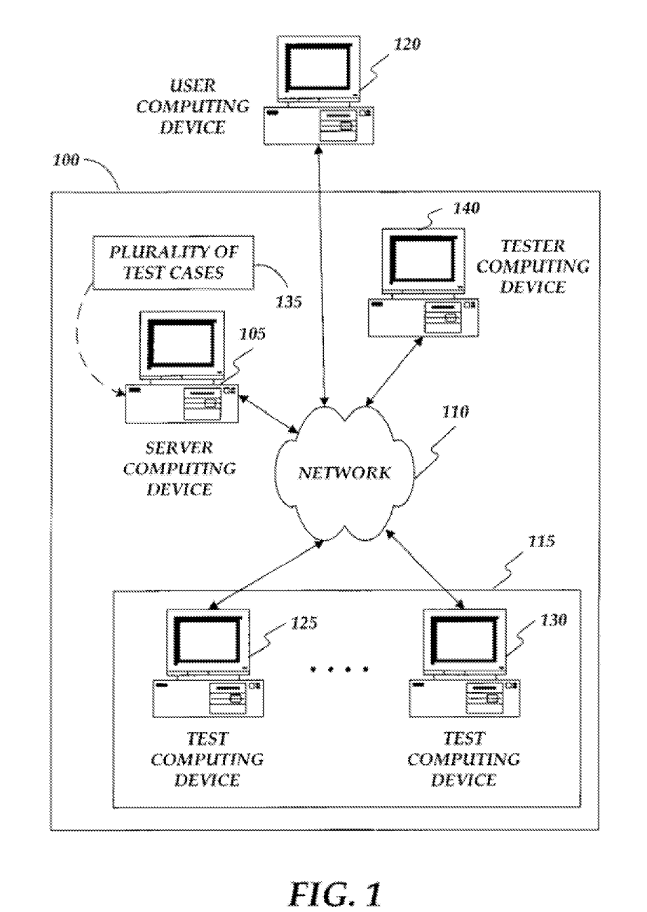

FIG. 1 is a block diagram of an automation testing system 100 consistent with an embodiment of the invention. System 100 may include a server computing device 105, a network 110, and a plurality of test computing devices 115. Server computing device 105 may communicate with a user computing device 120 over network 110. Similarly, server computing device 105 may communicate with a tester computing device 140 over network 110. Plurality of test computing devices 115 may include, but is not limited to, testing computing devices 125 and 130. In addition, plurality of test computing devices 115 may comprise a plurality of test computing devices in, for example, a test laboratory controlled by server computing device 105. Plurality of test computing devices 115 may each have different microprocessor models and/or different processing speeds. Furthermore, plurality of test computing devices 115 may each have different operating systems and hardware components.

Consistent with embodiments of the invention, code coverage data may be collected using system 100. System 100 may perform a run or series of runs. A run may comprise executing one or more test cases (e.g. a plurality of test cases 135) targeting a single configuration. A configuration may comprise a state of the plurality of test computing devices 115 including hardware, architecture, locale, and operating system. A suite may comprise a collection of runs. System 100 may collect code coverage data (e.g. traces) resulting from running the test cases.

Network 110 may comprise, for example, a local area network (LAN) or a wide area network (WAN). Such networking environments are commonplace in offices, enterprise-wide computer networks, intranets, and the Internet. When a LAN is used as network 110, a network interface located at any of the computing devices may be used to interconnect any of the computing devices. When network 110 is implemented in a WAN networking environment, such as the Internet, the computing devices may typically include an internal or external modem (not shown) or other means for establishing communications over the WAN. Further, in utilizing network 110, data sent over network 110 may be encrypted to insure data security by using encryption/decryption techniques.

In addition to utilizing a wire line communications system as network 110, a wireless communications system, or a combination of wire line and wireless may be utilized as network 110 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The computing devices in the wireless environment can be any mobile terminal, such as the mobile terminals described above. Wireless data ay include, but is not limited to, paging, text messaging, e-mail, Internet access and other specialized data applications specifically excluding or including voice transmission. For example, the computing devices may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN IEEE 802), a bluetooth interface, another RF communication interface, and/or an optical interface.

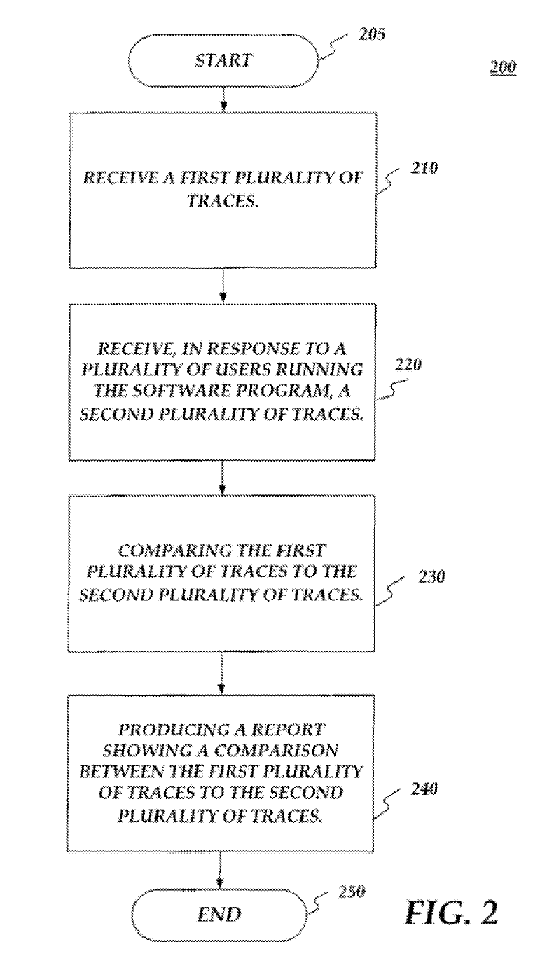

FIG. 2 is a flow chart setting forth the general stages involved in a method 200 consistent with an embodiment of the invention for providing code coverage data. Method 200 may be implemented using computing device 105 as described in more detail below with respect to FIG. 1. Ways to implement the stages of method 200 will be described in greater detail below. Method 200 may begin at starting block 205 and proceed to stage 210 where computing device 105 may receive, in response to running plurality of different test cases 135, a first plurality of traces. Each of the first plurality of traces may respectively correspond to a first plurality of outputs respectively produced by running each of plurality of different test cases 135 on the software program. For example, a software developer may wish to test the software program. When developing software, software programs may be tested during the development process. Such testing may produce code coverage data. Code coverage data may comprise metrics that may indicate what code pieces within a tested software program have been executed during the software program's test.

Each one of plurality of different test cases 135 may be configured to test a different aspect of the software program. To do so, plurality of test cases 135 may operate on a binary executable version of the software program populated with coverage code. For example, one of plurality of test cases 135 may be configured to cause the binary executable version to open a file, while another one of plurality of test cases 135 may cause the binary executable version to perform another operation. Consequently, the coverage code in the binary executable version may be configured to produce the code coverage data configured to indicate what code within the binary executable version was used during the test. In this test example, the coverage code may produce the code coverage data indicating what code within the binary executable version was executed during the file opening test.

Plurality of test computing devices 115 may comprise a plurality of test computing devices in, for example, a test laboratory controlled by server computing device 105. To run plurality of test cases 135, server computing device 105 may transmit, over network 110, plurality of test cases 135 to plurality of test computing devices 115. Server computing device 105 may oversee running plurality of test cases 135 on plurality of test computing devices 115 over network 110. Before running plurality of test cases 135, plurality of test computing device 115 may be setup in a single configuration. A configuration may comprise the state of plurality of test computing devices 115 including hardware, architecture, locale, and operating system. Locale may comprise a language in which the software program is to user interface. For example, plurality of test computing devices 115 may be setup in a configuration to test a word processing software program that is configured to interface with users in Arabic. Arabic is an example and any language may be used.

Computing device 105 may receive, in response to running a plurality of test cases 135, the first plurality of traces. Each of the first plurality of traces may respectively correspond to a plurality of outputs respectively produced by each of plurality of test cases 135. For example, a trace may comprise a unit of code coverage data collected from a test case run. A trace may comprise code blocks executed from the beginning to the end of the test case. For example, the tester may collect one trace for each test case run. In the above file opening example, the trace returned from such a test case may indicate all lines of code in the software program that were executed by the software program by the file open test case.

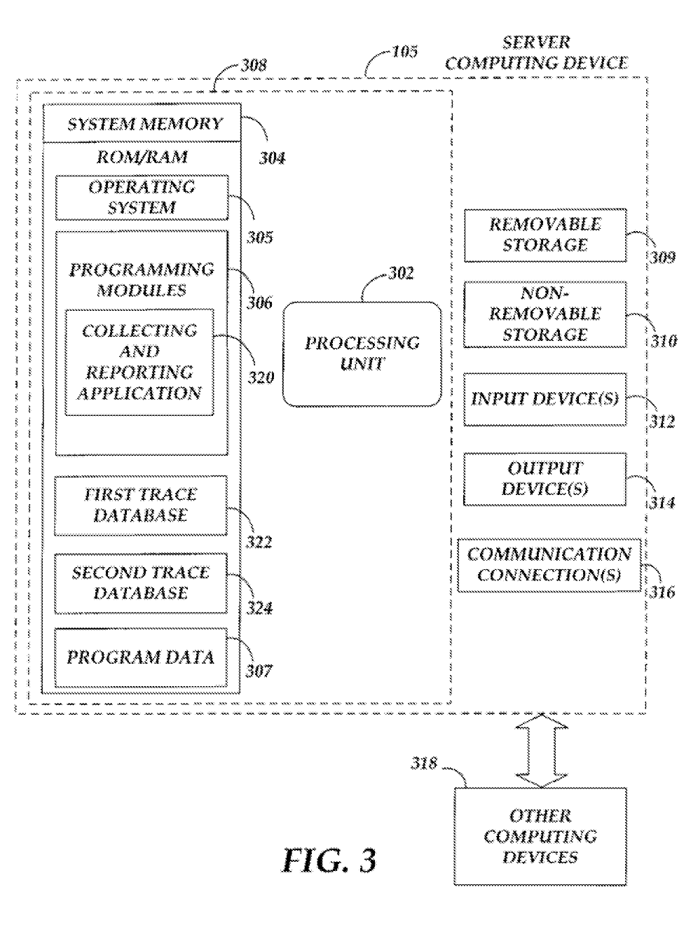

Plurality of test cases 135 running on plurality of test computing devices 115 may respectively produce the first plurality of traces. For example, a first line of code corresponding to the software program may be executed by a first test case within plurality of different test cases 135 and the same first line of code may be executed by a second test case within plurality of different test cases 135. Corresponding traces produced by the first and second test cases may indicate that both test cases covered the same code line. Once plurality of test computing devices 115 produce the first plurality of traces, plurality of test computing devices 115 may transmit the first plurality of traces to server computing device 105 over network 110. Server computing device 105 may then save the first plurality of traces to a first trace data base 322 as described in more detail below with respect to FIG. 3.

From stage 210, where computing device 105 receives the first plurality of traces, method 200 may advance to stage 220 where computing device 105 may receive, in response to a plurality of users running the software program, a second plurality of traces. Each of the second plurality of traces may respectively correspond to a second plurality of outputs produced by the users running the software program. For example, users using user computing device 120 (or other similar devices) may be provided with binary executable versions of the software program populated with coverage code. Consequently, the coverage code in the provided binary executable versions may be configured to produce code coverage data configured to indicate what code within the binary executable version is used when the users use the software program. In this way, the code coverage data may be produced to show what code may be covered by real users who actually use the software program for its intended purpose.

To gather the code coverage data from the users, a background service, may be deployed on user computing device 120 alongside the software program. The background service may collect the code coverage data from user computing device 120 and send it to server computing device 105 for processing. The background service may collect the code coverage data at regular intervals in addition to generating a special file that may indicate a version of the software program from which the code coverage data originated. To transmit the data, the background service may provide a data file manifest. These files may be packaged and queued to be transmitted. As user computing device 120 produces ones of the second plurality of traces, user computing device 120 may transmit the second plurality of traces to server computing device 105 over network 110. Server computing device 105 may then save the second plurality of traces to a second trace data base 324 as described in more detail below with respect to FIG. 3.

Once computing device 105 receives the second plurality of traces in stage 220, method 200 may continue to stage 230 where computing device 105 may compare the first plurality of traces to the second plurality of traces. For example, as shown in Table 1, a results database may be constructed having records for each code block in the software program.

TABLE 1

| Code Blocks | First Trace Database 322 | Second Trace Database 324 |
|---|---|---|
| Block 1 | 1 | 1 |
| Block 2 | 1 | 0 |
| Block 3 | 0 | 1 |
| Block 4 | 0 | 0 |

For each code block, the results database may indicate whether the block was covered by formal testing (e.g. from first trace database 322), by user use (e.g. from second trace database 324), by both formal testing and user use, or by neither. For example, as shown in Table 1, the software program's Block 1 was covered by both formal testing and user use, Block 2 was covered only by formal testing. Block 3 was covered by only user use, and Block 4 was covered by neither formal testing or user use. Furthermore, a similar comparison may be performed on a function level as shown in Table 2 regarding functions within the software program.

TABLE 2

| Functions | First Trace Database 322 | Second Trace Database 324 |
|---|---|---|
| Function 1 | 0 | 1 |
| (Blocks 8–10) | | |
| Function 2 | 1 | 1 |
| (Blocks 22–89) | | |
| Function 3 | 0 | 0 |
| (Blocks 13–18) | | |
| Function 4 | 1 | 0 |
| (Blocks 223–513) | | |

After computing device 105 compares the first plurality of traces to the second plurality of traces in stage 230, method 200 may proceed to stage 240 where computing device 105 may produce a report showing a comparison between the first plurality of traces to the second plurality of traces. For example, server computing device 105 may provide a website over network 110 that may be used to display the code coverage data, for example, for each block (e.g. Table 1) or for each function (e.g. Table 2) of the software program. The website may offer different views to tester computer device 140 to examine the data organized by the teams, testers, developers, or the component to which the data belongs. For builds in which comparison results exist, the website user can toggle comparison options that show the results of comparing the data from formal testing side-by-side with the data from users. Once computing device 105 produces the report in stage 240, method 200 may then end at stage 250.

An embodiment consistent with the invention may comprise a system for providing code coverage data. The system may comprise a memory storage and a processing unit coupled to the memory stage. The processing unit may be operative to receive, in response to running a plurality of different test cases, a first plurality of traces. Each of the first plurality of traces may respectively correspond to a first plurality of outputs respectively produced by running each of the plurality of different test cases on a software program. In addition, the processing unit may be operative to receive, in response to a plurality of users running the software program, a second plurality of traces. Each of the second plurality of traces may respectively correspond to a second plurality of outputs produced by the users running the software program. Furthermore, the processing unit may be operative to compare the first plurality of traces to the second plurality of traces.

Another embodiment consistent with the invention may comprise a system for providing code coverage data. The system may comprise a memory storage and a processing unit coupled to the memory storage. The processing unit may be operative to receive, in response to a plurality of users running a software program, a second plurality of traces. Each of the second plurality of traces may respectively correspond to a second plurality of outputs produced by the users running the software program. Furthermore, the processing unit may be operative to compare a first plurality of traces to the second plurality of traces. The first plurality of traces may comprise a testing baseline produced by a developer of the software program. The processing unit may be further operative to produce a report showing a comparison between the first plurality of traces to the second plurality of traces.

Yet another embodiment consistent with the invention may comprise a system for providing code coverage data. The system may comprise a memory storage and a processing unit coupled to the memory storage. The processing unit may be operative to receive a second plurality of traces produced by users running a software program. In addition, the processing unit may be operative to receive the second plurality of traces in response to each of a plurality of users respectively running the software program for a personal reason. The software program may be run by the users and may be configured to transmit each one of the second plurality of traces to the processing unit without intervention from any of the plurality of users. Furthermore, the processing unit may be operative to compare a first plurality of traces to the second plurality of traces. The first plurality of traces may comprise a testing baseline produced by a developer of the software program. Moreover, the processing unit may be operative to produce, in response to comparing the first plurality of traces to the second plurality of traces, a report identifying at least one of the following: i) blocks of code that were executed by both a plurality of different test cases received from the testing baseline and by the plurality of users as received from the second plurality of traces, ii) blocks of code executed by the plurality of different test cases but not executed by the plurality of users, iii) blocks of code executed by the plurality of users but not executed by the plurality of different test cases, and iv) blocks of code executed by neither the plurality of different test cases nor the plurality of users. In addition, the processing unit may be operative to transmit the report to at least one testing entity comprising one of the following: i) a person responsible for testing the software program and ii) a group of people responsible for testing the software program within an enterprise.

FIG. 3 is a block diagram of a system including computing device 105. Consistent with an embodiment of the invention, the aforementioned memory storage and processing unit may be implemented in a computing device, such as computing device 105 of FIG. 3. Any suitable combination of hardware, software, or firmware may be used to implement the memory storage and processing unit. For example, the memory storage and processing unit may be implemented with computing device 105 or any of other computing devices 318, in combination with computing device 105. The aforementioned system, device, and processors are examples and other systems, devices, and processors may comprise the aforementioned memory storage and processing unit, consistent with embodiments of the invention.

With reference to FIG. 3, a system consistent with an embodiment of the invention may include a computing device, such as computing device 105. In a basic configuration, computing device 105 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a program data 307. System memory 304 may also include first trace database 322 and second trace database 324 in which server computing device 105 may respectively save the first plurality of traces and the second plurality of trace. First trace database 322 may contain the code coverage data gathered from formal testing (e.g. the first plurality of traces). Second trace data base 324 may contain code coverage gathered from the software program's users (e.g. the second plurality of traces). Operating system 305, for example, may be suitable for controlling computing device 105's operation. In one embodiment, programming modules 306 may include, for example a collecting and reporting application 320. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 105 may have additional features or functionality. For example, computing device 105 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 105. Any such computer storage media may be part of device 105. Computing device 105 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 105 may also contain a communication connection 316 that may allow device 105 to communication with other computing devices 318, such as over a network (e.g. network 110) in a distributed computing environment, for example, an intranet or the Internet. As described above, other computing devices 318 may include plurality of test computing devices 115. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g. collecting and reporting application 320) may perform processes including, for example, one or more method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single-chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated single on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing code coverage data, the method comprising:
receiving, in response to running a plurality of different test cases, a first plurality of traces, each of the first plurality of traces respectively corresponding to a first plurality of outputs respectively produced by running each of the plurality of different test cases on a software program;
receiving, in response to a plurality of users running the software program, a second plurality of traces, each of the second plurality of traces respectively corresponding to a second plurality of outputs produced by the users running the software program; and
comparing the first plurality of traces to the second plurality of traces.

2. The method of claim 1, wherein receiving the first plurality of traces comprises receiving the first plurality of traces wherein the first plurality of traces each respectively indicates code lines corresponding to the software program that were executed as a result of running the plurality of different test cases.

3. The method of claim 1, wherein receiving the first plurality of traces comprises receiving the first plurality of traces wherein the first plurality of traces each respectively indicates code lines corresponding to the software program that were executed as a result of running the plurality of different test cases wherein a first line of code corresponding to the software program was executed by a first test case within the plurality of different test cases and the first line of code corresponding to the software program was executed by a second test case within the plurality of different test cases.

4. The method of claim 1, wherein receiving the second plurality of traces comprises receiving the second plurality of traces in response to each of the plurality of users respectively running the software program for a personal reason.

5. The method of claim 1, wherein receiving the second plurality of traces comprises receiving the second plurality of traces in response to each of the plurality of users respectively running the software program, the software program being configured to transmit each one of the second plurality of traces without intervention from any of the plurality of users.

6. The method of claim 1, wherein comparing the first plurality of traces to the second plurality of traces comprises:
determining from the first plurality of traces blocks of code executed by the plurality of different test cases; and
determining from the second plurality of traces blocks of code executed by the plurality of users.

7. The method of claim 6, further comprising producing a report identifying at least one of the following: blocks of code that were executed by both the plurality of different test cases and by the plurality of users, blocks of code executed by the plurality of different test cases but not executed by the plurality of users, blocks of code executed by the plurality of users but not executed by the plurality of different test cases, and blocks of code not executed by either the plurality of different test cases nor the plurality of users.

8. The method of claim 1, wherein comparing the first plurality of traces to the second plurality of traces comprises:
determining, from the first plurality of traces, blocks of code executed by the plurality of different test cases;
determining, from the blocks of code executed by the plurality of different test cases, functions executed by the plurality of different test cases;
determining, from the second plurality of traces, blocks of code executed by the plurality of users; and
determining, from the blocks of code executed by the plurality of users, functions executed by the plurality of users.

9. The method of claim 8, further comprising producing a report identifying at least one of the following functions that were executed by both the plurality of different test cases and by the plurality of users, functions executed by the plurality of different test cases but not executed by the plurality of users, functions executed by the plurality of users but not executed by the plurality of different test cases, and functions not executed by either the plurality of different test cases nor the plurality of users.

10. The method of claim 1, further comprising running the plurality of different test cases.

11. The method of claim 10, wherein running the plurality of different test cases comprises running the plurality of different test cases wherein each of the plurality of different test cases is respectively configured to test a different aspect of the software program.

12. The method of claim 1, further comprising, in response to comparing the first plurality of traces to the second plurality of traces, producing a report showing a comparison between the first plurality of traces to the second plurality of traces.

13. The method of claim 12, further comprising transmitting the report to at least one testing entity comprising one of the following: a person responsible for testing the software program and a group of people responsible for testing the software program within an enterprise.

14. A computer-readable medium which stores a set of instructions which when executed performs a method for providing code coverage data, the method executed by the set of instructions comprising:
receiving, in response to a plurality of users running a software program, a second plurality of traces, each of the second plurality of traces respectively corresponding to a second plurality of outputs produced by the users running the software program;
comparing a first plurality of traces to the second plurality of traces, the first plurality of traces comprising a testing baseline produced by a developer of the software program; and
producing a report showing a comparison between the first plurality of traces to the second plurality of traces.

15. The computer-readable medium of claim 14, further comprising transmitting the report to at least one testing entity comprising one of the following: a person responsible for testing the software program and a group of people responsible for testing the software program within an enterprise.

16. The computer-readable medium of claim 14, wherein comparing the first plurality of traces to the second plurality of traces comprises:
determining, from the first plurality of traces, block of code executed by a plurality of different test cases; and
determining, from the second plurality of traces, blocks of code executed by the plurality of users.

17. The computer-readable medium of claim 16, wherein producing the report comprises producing the report identifying at least one of the following: blocks of code that were executed by both the plurality of different test cases and by the plurality of users, blocks of code executed by the plurality of different test cases but not executed by the plurality of users, blocks of code executed by the plurality of users but not executed by the plurality of different test cases, and blocks of code not executed by either the plurality of different test cases nor the plurality of users.

18. The computer-readable medium of claim 16, wherein comparing the first plurality of traces to the second plurality of traces comprises:
determining, from the first plurality of traces, blocks of code executed by the plurality of different test cases;
determining, from the blocks of code executed by the plurality of different test cases, functions executed by the plurality of different test cases;
determining, from the second plurality of traces, blocks of code executed by the plurality of users; and
determining, from the blocks of code executed by the plurality of users, functions executed by the plurality of users.

19. The computer-readable medium of claim 16, wherein producing the report comprises producing the report identifying at least one of the following: functions that were executed by both the plurality of different test cases and by the plurality of users, functions executed by the plurality of different test cases but not executed by the plurality of users, functions executed by the plurality of users but not executed by the plurality of different test cases, and functions not executed by either the plurality of different test cases nor the plurality of users.

20. A system for providing code coverage data, the system comprising:
a memory storage; and
a processing unit coupled to the memory storage, wherein the processing unit is operative to:
receive a second plurality of traces produced by users running a software program, the processing unit being operative to receive the second plurality of traces in response to each of a plurality of users respectively running the software program for a personal reason, the software program being run by the users and being configured to transmit each one of the second plurality of traces to the processing unit without intervention from any of the plurality of users;
compare a first plurality of traces to the second plurality of traces, the first plurality of traces comprising a testing baseline produced by a developer of the software program;
produce, in response to comparing the first plurality of traces to the second plurality of traces, a report identifying at least one of the following: blocks of code that were executed by both a plurality of different test cases received from the testing baseline and by the plurality of users as received from the second plurality of traces, blocks of code executed by the plurality of different test cases but not executed by the plurality of users, blocks of code executed by the plurality of users but not executed by the plurality of different test cases, and blocks of code not executed by either the plurality of different test cases nor the plurality of users; and
transmit the report to at least one testing entity comprising one of the following: a person responsible for testing the software program and a group of people responsible for testing the software program within an enterprise.
